(19) United States
(12) Patent Application Publication
(10) Pub. No.: US 2026/0208984 A1
(43) Pub. Date: Jul. 23, 2026

(54) Paddle Sweep Assembly Having Adjustable Length

(71) Applicant: CTB, Inc., Milford, IN (US)

(72) Inventors: Tauren N. THOMPSON, Granger, IN (US); Jeffrey E. WALKER, Fort Wayne, IN (US); Mark S. DINGELDEIN, Milford, IN (US)

(73) Assignee: CTB, Inc., Milford, IN (US)

(21) Appl. No.: 19/452,766

(22) Filed: Jan. 19, 2026

Related U.S. Application Data
(60) Provisional application No. 63/747,221, filed on Jan. 20, 2025.

(51) Int. Cl. B65G 65/34; B65G 19/12; B65G 21/14

(52) U.S. Cl. CPC B65G 65/34; B65G 19/12; B65G 21/14

(57) ABSTRACT

A paddle sweep assembly includes a frame, a chain, and a plurality of paddles. The chain extends in a loop within the frame. The chain is coupled to the frame in a way that allows the chain to rotate through the loop. The paddles are connected to the chain. The length of the paddle sweep assembly is adjustable.

### CROSS-REFERENCE TO RELATED APPLICATIONS

This application claims the benefit of U.S. Provisional Application No. 63/747,221, filed on January 20, 2025. The entire disclosure of the above application is incorporated herein by reference.

### FIELD

The present disclosure relates to paddle sweep assemblies having an adjustable length.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Paddle sweep assemblies are becoming an increasingly popular alternative to auger sweep assemblies for removing grain from a grain bin. A paddle sweep assembly directs grain on a floor of a grain bin towards sumps in the grain bin floor to remove the grain from the grain bin. The paddle sweep assembly accomplishes this by pushing grain in a direction from an outer cylindrical wall of the grain bin toward the center of the grain bin while by rotating about a pivot disposed at or near the center of the grain bin. As the paddle sweep assembly pushes the grain toward the center of the grain bin, the grain falls through sumps in the grain bin floor to a trough disposed below the grain bin floor. The trough contains a mechanism such as a conveyor auger that moves the grain to a location outside of the perimeter of the grain bin.

A paddle sweep assembly typically includes a pivot mechanism, an elongated housing or frame having one end connected to the pivot mechanism, a plurality of paddles connected to a belt or chain that extends in a loop within the frame, and drive mechanisms that drive the belt or chain and rotate the frame about the pivot mechanism. The belt or chain is wrapped around pulleys or pinion gears disposed at each end of the loop, and the drive mechanisms include a motor that rotates one of the pulleys or pinion gears. The drive mechanisms also include one or more drive wheels coupled to the other end of the frame that rotate the frame about the pivot mechanism.

Paddle sweep assemblies typically have a fixed length that is based on standard sizes of grain bins. For example, the length of a paddle sweep assembly may be roughly equal to the inner radius of a grain bin. However, some grain bins have features that prevent extending the paddle sweep assembly to the grain bin wall, such as a door or ladder that projects further into the grain bin than is typical, or a grain bin that is not round. In these instances, an entirely different frame can be used to yield a paddle sweep assembly having a slightly shorter length. This leads to a proliferation of parts and, in turn, increases manufacturing costs.

### SUMMARY

An example of a paddle sweep assembly according to the present disclosure includes a frame, a chain, and a plurality of paddles. The chain extends in a loop within the frame. The chain is coupled to the frame in a way that allows the chain to rotate through the loop. The paddles are connected to the chain. The length of the paddle sweep assembly is adjustable.

In one aspect, the frame includes a first frame segment, a second frame segment, and at least one adjustment mechanism that connects the first second frame segments together. The adjustment mechanism is manipulatable to increase or decrease an amount by which the first and second frame segments overlap, and thereby increase or decrease the length of the frame.

In one aspect, one end of the loop formed by the chain is coupled to the frame on one side of the at least one adjustment mechanism along the length of the frame, and the other end of the loop formed by the chain is coupled to the frame on the other side of the at least one adjustment mechanism along the length of the frame.

In one aspect, the chain includes a number of links, and the number of the links included in the chain is adjustable to adjust the length of the loop formed by the chain.

In one aspect, the first frame segment is slidable within the second frame segment in a telescoping manner.

In one aspect, the at least one adjustment mechanism includes a first adjustment mechanism attached to a front side of the frame and a second adjustment mechanism attached to a back side of the frame.

In one aspect, the at least one adjustment mechanism includes a bracket, a bolt, and a pair of nuts. The bracket is attached to one of the first and second frame segments. The bolt extends through a flange on the other one of the first and second frame segments and abuts the bracket. The nuts are threaded onto the bolt on opposite sides of the flange to lock the bolt in place.

In one aspect, the bracket includes a pair of side walls and the bolt extends through a hole in one of the side walls and abuts the other one of the side walls.

In one aspect, the flange projects from the perimeter of the other one of the first and second frame segments and extends along at least one side thereof.

In one aspect, loosening one of the nuts enables the bolt to be rotated, and rotating the bolt adjusts the amount by which the first and second frame segments overlap.

In one aspect, each of the first and second frame segments includes at least one top wall, a bottom wall, and a pair of side walls opposite of one another and joining the top and bottom walls together.

In one aspect, the paddle sweep assembly further includes a flow restrictor plate attached to one the side walls of at least one of the first and second frame segments on a front side thereof. The flow restrictor plate is vertically adjustable.

An example of a grain bin emptying assembly according to the present disclosure includes the paddle sweep assembly, which further includes a drive gear coupled to the frame and a driven gear coupled to the frame, and a motor coupled to the drive gear. The chain extends in the loop around the drive gear and the driven gear. The motor is operable to rotate the drive gear and thereby rotate the chain through the loop.

In one aspect, the grain bin emptying assembly further includes a pivot mechanism coupling the drive gear to the motor and a drive wheel supporting the frame. The drive wheel is coupled to the driven gear such that rotating the chain rotates the frame about the pivot mechanism.

In one aspect, the length of the frame is adjustable by a distance that is greater than or equal to 30.5 centimeters.

Another grain bin emptying assembly according to the present disclosure includes a pivot mechanism configured to be located at or near a center of a grain bin, and a paddle sweep assembly operable to rotate around the grain bin about the pivot mechanism. The paddle sweep assembly includes a frame attached to the pivot mechanism, a chain extending in a loop within the frame and coupled to the frame in a way that allows the chain to rotate through the loop, and a plurality of paddles connected to the chain and configured to push grain toward the center of the grain bin. The length of the paddle sweep assembly is adjustable.

In one aspect, the paddle sweep assembly includes a drive gear coupled to the frame and a driven gear coupled to the frame, the chain extends in the loop around the drive gear and the driven gear, the grain bin emptying assembly further includes a motor coupled to the drive gear. The motor is operable to rotate the drive gear and thereby rotate the chain through the loop.

In one aspect, the frame includes a first frame segment, a second frame segment, and an adjustment mechanism. The first frame segment is slidable within the second frame segment in a telescoping manner. The adjustment mechanism connects the first second frame segments together and is manipulatable to increase or decrease an amount by which the first and second frame segments overlap, and thereby increase or decrease the length of the frame.

In one aspect, one end of the loop formed by the chain is coupled to the frame on one side of the adjustment mechanism along the length of the frame, and the other end of the loop formed by the chain is coupled to the frame on the other side of the adjustment mechanism along the length of the frame.

In one aspect, the adjustment mechanism includes a bracket, a bolt, and a nut. The bracket is attached to one of the first and second frame segments. The bolt extends through a flange on the other one of the first and second frame segments and abuts the bracket. The nut is threaded onto the bolt and fixed to the flange. Rotating the bolt adjusts a distance between the bracket and the flange.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example grain bin emptying assembly including a conveyor auger assembly and a paddle sweep assembly according to the present disclosure that directs grain toward a plurality of sumps in a grain bin floor;

FIGS. 2 and 3 are perspective views of the paddle sweep assembly of FIG. 1, the paddle sweep assembly including a head section, a tail section, and an adjustable length section;

FIG. 4 and 5 are perspective views of the head section;

FIG. 6 and 7 are perspective views of the tail section;

FIG. 8 and 9 are perspective views of the adjustable length section including a frame subassembly and a paddle subassembly disposed within the frame subassembly;

FIGS. 10 and 11 are perspective views of the frame subassembly in a fully collapsed state and a fully extended state, respectively;

FIG. 12 includes a side view of the frame subassembly in a fully collapsed state and a side view of the frame subassembly in a fully extended state;

FIGS. 13 through 16 are additional perspective views of the frame subassembly in its fully extended state; and

FIGS. 17 and 18 are perspective views of an alternative embodiment of the frame assembly including a flow restrictor plate on the front side thereof.

In the drawings, reference numbers may be reused to identify similar and/or identical elements.

### DETAILED DESCRIPTION

A paddle sweep assembly according to the present disclosure has an adjustable length. In one example, the paddle sweep assembly includes a first frame segment, a second frame segment, and an adjustment mechanism that connects the first and second frame segments together. The adjustment mechanism can be manipulated to increase or decrease the amount by which the first and second frame segments overlap, and thereby increase or decrease the length of the frame. This avoids the need to use entirely different frames for grain bins of similar sizes, which reduces manufacturing costs. In addition, the paddle sweep assembly includes a plurality of paddles connected to a chain extending in a loop within the frame, and a link can be added to or subtracted from the chain to increase or decrease the length of the loop.

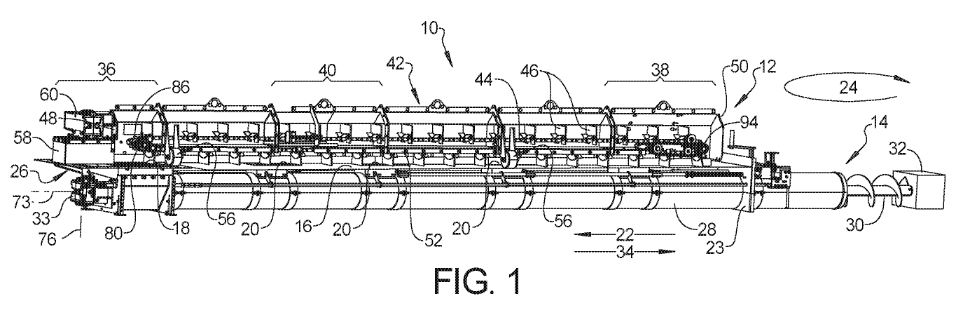

Referring now to FIG. 1, a grain bin emptying assembly 10 includes a paddle sweep assembly 12 and a conveyor auger assembly 14. The paddle sweep assembly 12 directs grain on a floor 16 of a grain bin towards a center sump 18 and a plurality of intermediate sumps 20 in the grain bin floor 16 to remove the grain from the grain bin. The paddle sweep assembly 12 accomplishes this by pushing grain in a radially inward direction 22 from an outer cylindrical wall of the grain bin toward the center of the grain bin while by rotating in a clockwise direction 24 (as viewed from above) about a pivot mechanism 26 disposed at or near the center of the grain bin. A plate 23 of the conveyor auger assembly 14 is located just outside of the grain bin. The grain bin floor 16 has a disk shape – only a portion of the grain bin floor 16 is shown.

The conveyor auger assembly 14 includes a trough 28, a conveyor auger 30, an electric motor 32, and a first gearbox 33. Grain falls into the trough 28 through the center sump 18 and the intermediate sumps 20. The motor 32 is disposed outside of the grain bin and rotates the conveyor auger 30, which in turn moves the grain in a radially outward direction 34 to a location outside of the perimeter of the grain bin. The center sump 18 and the intermediate sumps 20 may be considered part of the conveyor auger assembly 14. The first gearbox 33 is shiftable to connect the paddle sweep assembly 12 to the motor 32 or disconnect the paddle sweep assembly 12 from the motor 32. In the latter shift state, the motor 32 drives the conveyor auger assembly 14 but does not drive the paddle sweep assembly 12.

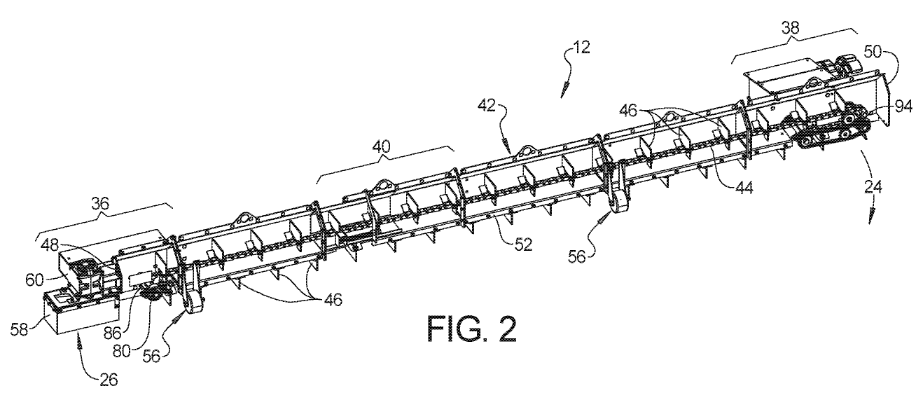

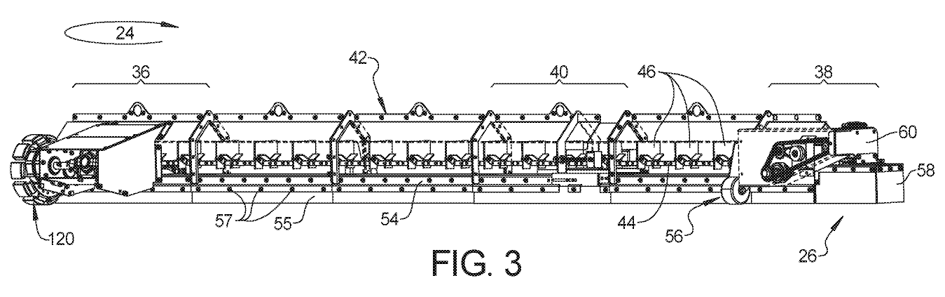

With additional reference to FIGS. 2 and 3, the paddle sweep assembly 12 includes a head section 36, a tail section 38, and an adjustable length section 40 disposed between the head and tail sections 36 and 38. The pivot mechanism 26 is disposed within or below the head section 36 and may be considered part of the paddle sweep assembly 12. The paddle sweep assembly 12 also includes a frame 42 that extends from the head section 36 to the tail section 38, a first chain 44 disposed within the frame 42 and extending in a loop that spans from the head section 36 to the tail section 38, and a plurality of paddles 46 connected to the first chain 44.

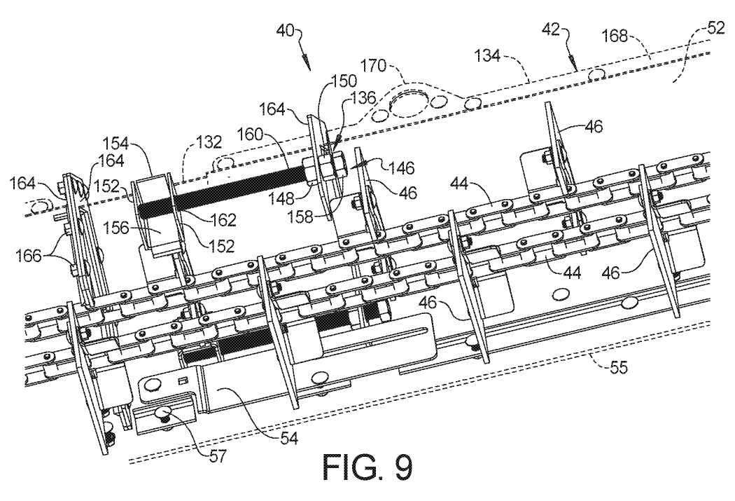

The frame 42 has an inboard end 48, an outboard end 50, a front side 52, and a back side 54. The paddle sweep assembly 12 also includes three caster wheels 56 – two attached to the front side 52 of the frame 42 and one attached to the back side 54 of the frame 42 – and a backboard 55 attached to the back side 54 of the frame 42 and extending downward from the frame 42. The backboard 55 holds the grain beneath the frame 42 so that the paddles 46 move more grain toward the sumps 18, 20 as the paddle sweep assembly 12 rotates around the grain bin. The backboard 55 is attached to the frame 42 using fasteners 57 (e.g., nuts and bolts). The portion of the backboard 55 through which the fasteners 57 extend may be made from metal (e.g., steel). The paddles 46 and the rest of the backboard 55 may be made from rubber. In FIGS. 2 through 9, portions of the frame 42 are made transparent to show components within the frame 42. For example, the front side 52 of the frame 42 is transparent in FIGS. 1 and 2, and the back side 54 of the frame is transparent in FIG. 3.

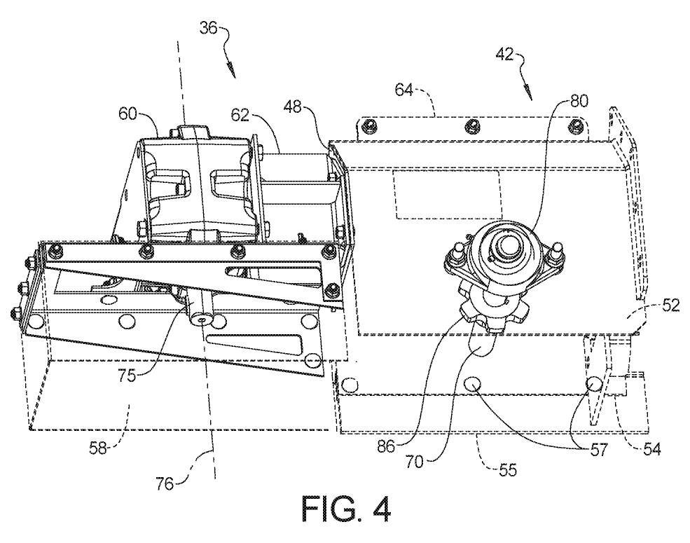

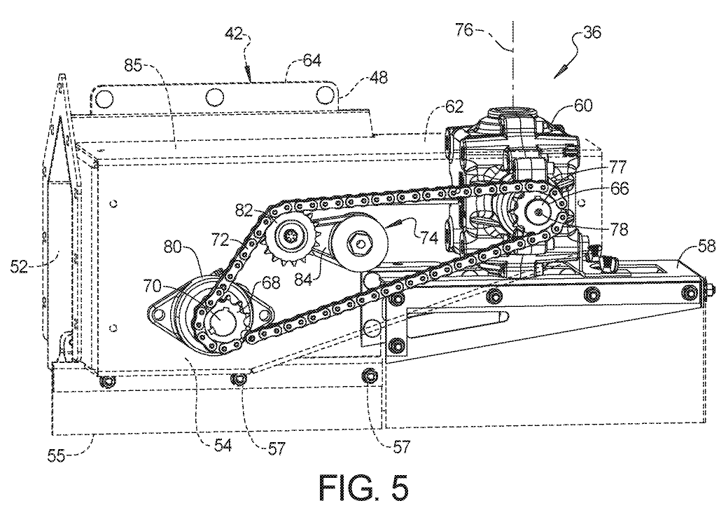

With additional reference to FIGS. 4 and 5, the head section 36 of the paddle sweep assembly 12 includes a pivot housing 58, a second gearbox 60, a transition segment 62, a head segment 64 of the frame 42, a drive gear 66, a driven gear 68, a first shaft 70, a second chain 72, and a tensioner 74. The pivot mechanism 26 may be disposed within and/or below the pivot housing 58. The second gearbox 60 is mounted to the pivot mechanism 26. The pivot mechanism 26 enables the second gearbox 60 to rotate about a vertical axis 76, and thereby enables the entire paddle sweep assembly 12 except for the pivot housing 58 to rotate about the vertical axis 76.

The transition segment 62 connects the second gearbox 60 to the head segment 64 of the frame 42. The motor 32 rotates the drive gear 66 via the conveyor auger 30 and the first and second gearboxes 33 and 60. The drive gear 66 is mounted to an output shaft 77 of the second gearbox 60. The first gearbox 33 converts the rotational motion of the motor 32 about a first horizontal axis 73 (FIG. 1) to rotational motion of an input shaft 75 (FIG. 4) of the second gearbox 60 about the vertical axis 76. The first horizontal axis 73 is colinear with the central longitudinal axis of the conveyor auger 30. The second gearbox 60 converts the rotational motion of its input shaft about the vertical axis 76 to rotational motion of the drive gear 66 about a second horizontal axis 78, which is colinear with the central longitudinal axis of the output shaft 77. In various implementations, the paddle sweep assembly 12 may include an electric motor disposed within the grain bin and coupled directly or indirectly to the first shaft 70. In such implementations, the paddle sweep assembly 12 is driven independent of the conveyor auger assembly 14, and the first gearbox 33, the second gearbox 60, and the components connecting the first shaft 70 to the second gearbox 60 may be omitted.

The second chain 72 forms a loop that extends around the drive gear 66 and the driven gear 68. The drive gear 66 drives the driven gear 68 by rotating the second chain 72 through its loop. The driven gear 68 is fixed to the first shaft 70, which is mounted to the head segment 64 of the frame 42 via a first pair of bearings 80. One bearing 80 is attached to the front side 52 of the frame 42, and the other bearing 80 is attached to the back side 54 of the frame 42. The bearings 80 enable the first shaft 70 to rotate relative to the frame 42. The tensioner 74 includes a tensioner gear 82 mounted on an arm 84, and a spring that biases the tensioner gear 82 into engagement with the second chain 72 and thereby maintains tension in the second chain 72.

The head section 36 of the paddle sweep assembly 12 further includes a first gear housing 85 and a drive gear 86. The first gear housing 85 is attached to the head segment 64 of the frame 42 and encloses the drive gear 66, the driven gear 68, the second chain 72, and the tensioner 74. The drive gear 86 is mounted to the first shaft 70 so that the drive gear 86 rotates with the first shaft 70. As shown in FIGS. 1 and 2, the first chain 44 to which the paddles 46 are connected extends around the drive gear 86. The drive gear 86 rotates the first chain 44 through its loop and thereby moves the paddles 46 in the radially inward and outward directions 22 and 34.

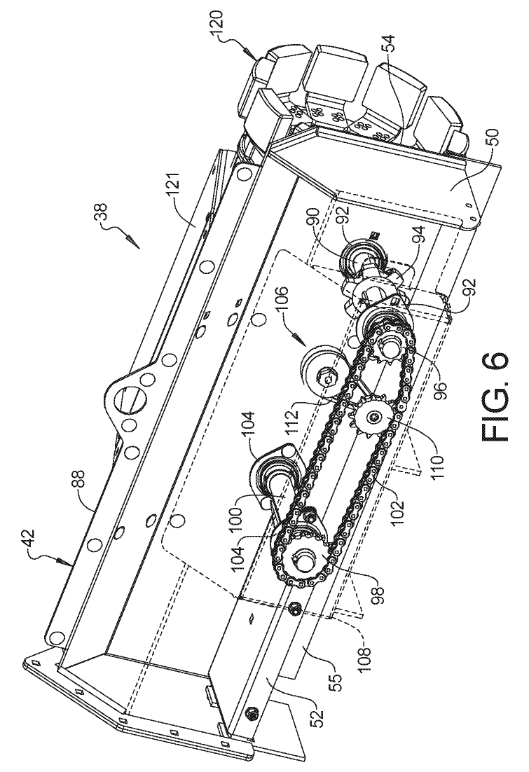

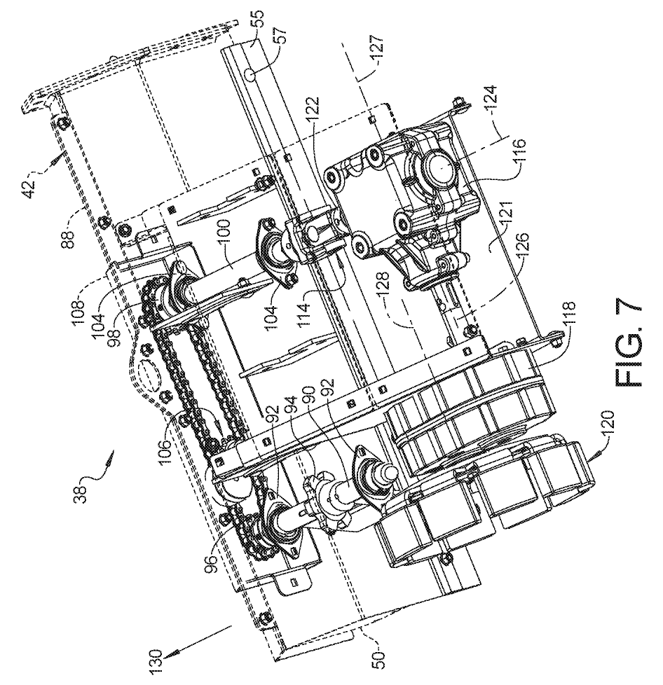

Referring now to FIGS. 6 and 7, the tail section 38 of the paddle sweep assembly 12 includes a tail segment 88 of the frame 42, a second shaft 90, a second pair of bearings 92, a driven gear 94, a drive gear 96, a driven gear 98, a third shaft 100, a third chain 102, a third pair of bearings 104, a tensioner 106, and a second gear housing 108. As shown in FIGS. 1 and 2, the first chain 44 to which the paddles 46 are connected extends around the driven gear 94. One end of the loop formed by the first chain 44 extends around the drive gear 86, and the other end of the loop formed by the first chain 44 extends around the driven gear 94. As the drive gear 86 rotates the first chain 44, the first chain 44 rotates the driven gear 94. In the example shown, the drive and driven gears 86 and 94 rotate about horizontal axes, and one section of the first chain 44 is disposed above another section of the first chain 44. In other examples, the drive and driven gears 86 and 94 may rotate about vertical axes, and one section of the first chain 44 may be disposed beside another section of the first chain 44.

Referring again to FIGS. 6 and 7, the driven gear 94 is fixed to the second shaft 90, which is mounted to the tail segment 88 of the frame 42 via the bearings 92. One bearing 92 is attached to the front side 52 of the frame 42, and the other bearing 92 is attached to the back side 54 of the frame 42. The bearings 92 enable the second shaft 90 to rotate relative to the frame 42. The drive gear 96 is also fixed to the second shaft 90 and is disposed outside of the frame 42. The second gear housing 108 is attached to the tail segment 88 of the frame 42 and encloses the drive gear 96, the driven gear 98, the third chain 102, and the tensioner 106.

The third chain 102 forms a loop that extends around the drive gear 96 and the driven gear 98. The drive gear 96 drives the driven gear 98 by rotating the third chain 102 through its loop. The driven gear 98 is fixed to the third shaft 100, which is mounted to the tail segment 88 of the frame 42 via the bearings 104. One bearing 104 is attached to the front side 52 of the frame 42, and the other bearing 104 is attached to the back side 54 of the frame 42. The tensioner 106 includes a tensioner gear 110 mounted on an arm 112, and a spring that biases the tensioner gear 110 into engagement with the third chain 102 and thereby maintains tension in the third chain 102.

The tail section 38 of the paddle sweep assembly 12 further includes a universal joint 114, a third gearbox 116, a transfer case 118, a drive wheel 120, and a third gear housing 121. The universal joint 114 couples the third shaft 100 to a first shaft 122 of the third gearbox 116 while allowing the first shaft 122 to be angled relative to the third shaft 100. The third gearbox 116 converts the rotational motion of the first shaft 122 about a first horizonal axis 124 to rotational motion of a second shaft 126 of the third gearbox 116 about a second horizontal axis 127 perpendicular to the first horizontal axis 124.

The transfer case 118 converts the rotational motion of the second shaft 126 about the second horizonal axis 127 to rotational motion of the drive wheel 120 about a third horizontal axis 128 that is parallel to and spaced apart from the second horizontal axis 127. The drive wheel 120 supports the outboard end 50 of the paddle sweep assembly 12 and rests on the grain bin floor 16 (FIG. 1) or on grain piled thereon. As the drive wheel 120 rotates, the drive wheel 120 drives the outboard end 50 of the paddle sweep assembly 12 in a forward direction 130, which causes the paddle sweep assembly 12 to rotate in the clockwise direction 24 about the grain bin. The third gear housing 121 is attached to the tail segment 88 of the frame 42 and encloses the universal joint 114 and the third gearbox 116.

In the example shown, the motor 32 both drives the drive gear 86 to rotate the first chain 44 through its loop and drives the drive wheel 120 to rotate the paddle sweep assembly 12 about the pivot mechanism 26. In various implementations, the drive gear 86 and the drive wheel 120 may be driven independent from one another. For example, the drive gear 86 may be driven by the motor 32, and the drive wheel 120 may be driven by a different motor.

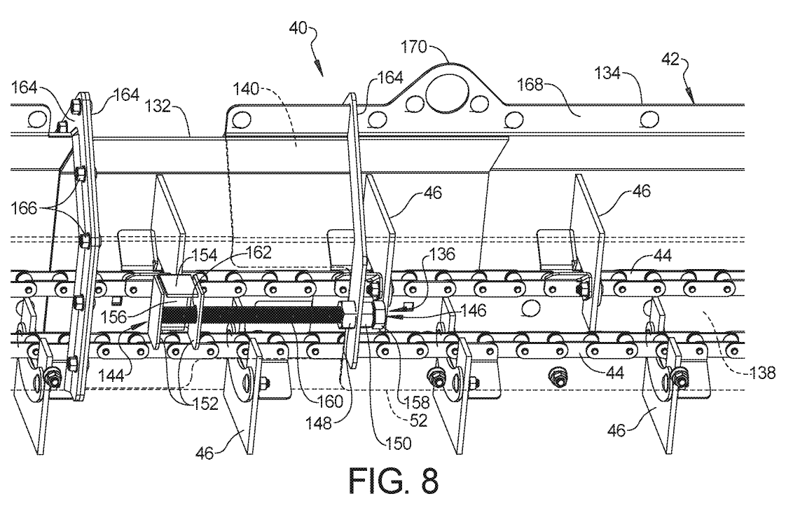

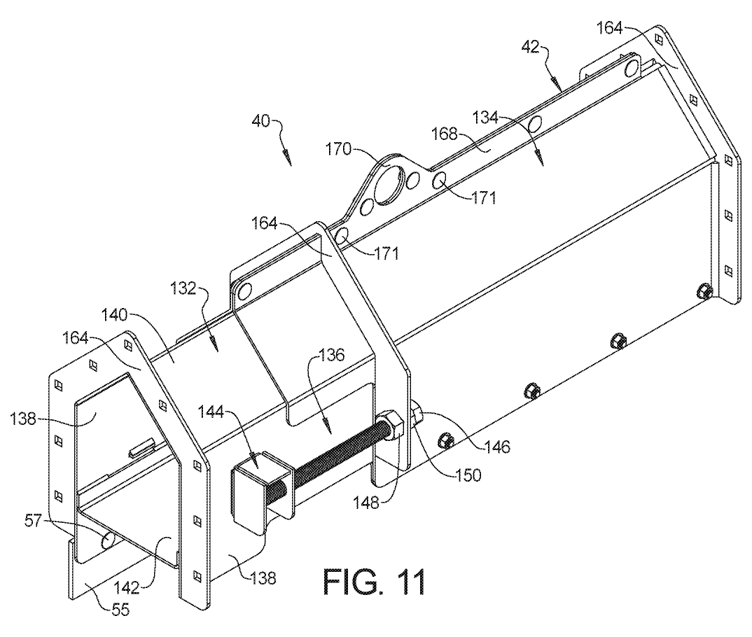

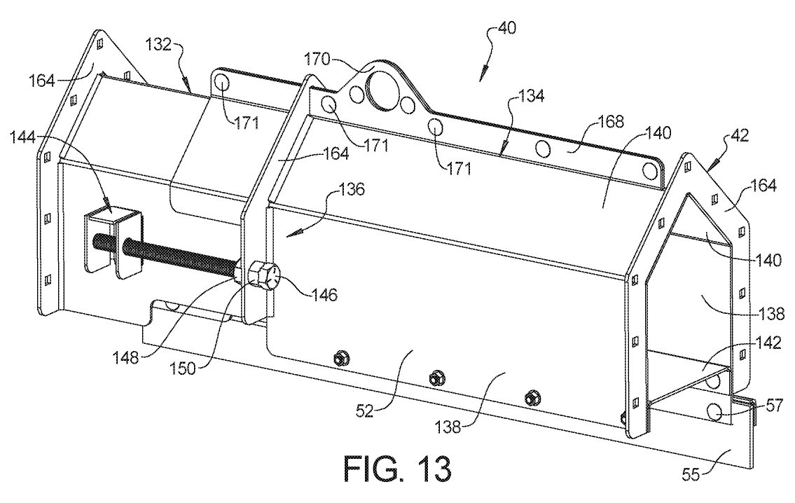

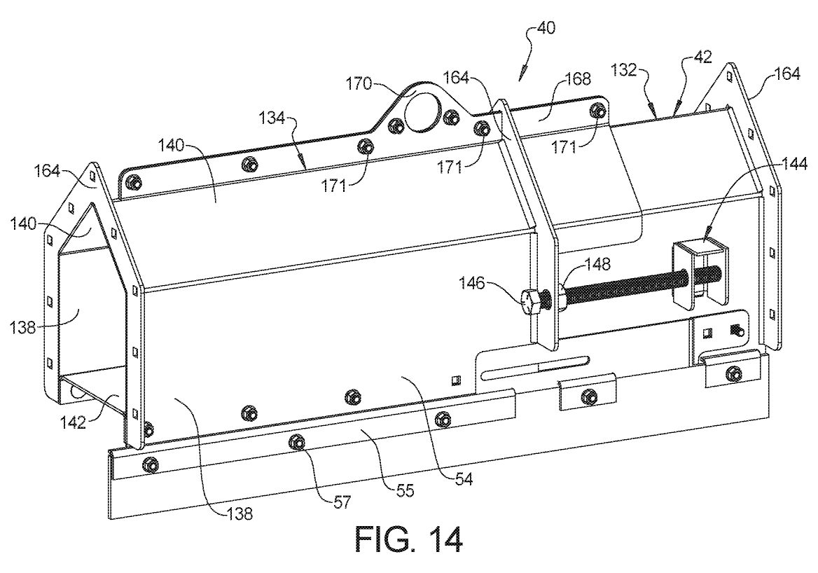

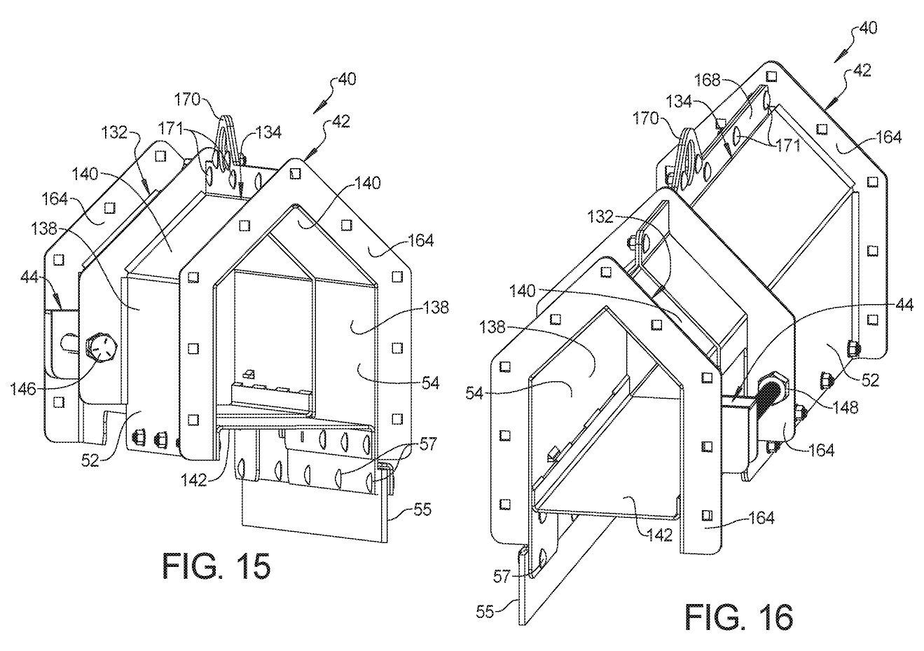

Referring now to FIGS. 8 through 16, the adjustable length section 40 of the paddle sweep assembly 12 includes a first frame segment 132, a second frame segment 134, and adjustment mechanisms 136 that connect the first second frame segments 132 and 134 together. The first and second frame segments 132 and 134 overlap one another, and the first frame segment 132 is slidable within the second frame segment 134 in a telescoping manner. Each segment of the frame 42 has a pentagon-shaped cross section with a pair of side walls 138, a pair of angled top walls 140, and a bottom wall 142. The bottom wall 142 is disposed between the upper half of the loop formed by the first chain 44 and the lower half of the loop formed by the first chain 44.

The adjustment mechanisms 136 can be manipulated to increase or decrease the amount by which the first and second frame segments 132 and 134 overlap, and thereby adjust the overall length of the frame 42. One adjustment mechanism 136 is attached to the front side 52 of the frame 42, and the other adjustment mechanism 136 is attached to the back side 54 of the frame 42. Each adjustment mechanism 136 includes a bracket 144, a threaded rod or bolt 146, a first nut 148, and a second nut 150.

The bracket 144 includes a pair of side walls 152, a top wall 154 extending between and connects the upper ends of the side walls 152, and a back wall 156 that extends between and connects the back edges of the side walls 152 and the back edge of the top wall 154. In various implementations, the top wall 154 and/or the back wall 156 may be omitted. The bolt 146 includes a head 158 and a shank 160. One of the side walls 152 of the bracket 144 has a hole 162 extending therethrough for receiving the shank 160 of the bolt 146. In the example shown, the bracket 144 is attached (e.g., welded) to one of the side walls 138 of the first frame segment 132, and the head 158 of the bolt 146 is disposed alongside the second frame segment 134. In other examples, the bracket 144 may be attached to one of the side walls 138 of the second frame segment 134, and the head 158 of the bolt 146 may be disposed alongside the first frame segment 132.

Each segment of the frame 42 includes at least one flange 164 projecting from the perimeter thereof for connecting the frame segment to an adjacent frame segment. The first frame segment 132 includes only one flange 164. The second frame segment 134 and other segments of the frame 42 includes two flanges 164. The flange 164 of the first frame segment 132 and one flange 164 of the second frame segment 134 abut the flange 164 of an adjacent frame segment. A plurality of fasteners 166 (e.g., nuts and bolts) extend through the flanges 164 and connect the frame segments together. The second frame segment 134 and other segments of the frame 42 also include a flange 168 that projects from the upper edges of the top walls 140 and forms a handle 170. Fasteners 171 (e.g., nuts and bolts) are inserted through holes in the flange 168 on the front side 52 of the frame 42 and through corresponding holes in the flange 168 on the back side 54 of the frame 42 to join the front and back sides 52 and 54 of the frame 42 to one another.

The adjustable length section 40 further includes portions of the upper and lower halves of the loop formed by the first chain 44, as well as the paddles 46 attached thereto.

The frame 42 or a portion thereof may be referred to as a frame subassembly. The adjustment mechanisms 136 may also be considered part of a frame subassembly. For example, the first and second frame segments 132 and 134 and the adjustment mechanisms 136 may be referred to collectively as a frame subassembly. The first chain 44 and the paddles 46, or portions thereof such as the portions included in the adjustable length section 40, may be referred to collectively as a paddle subassembly.

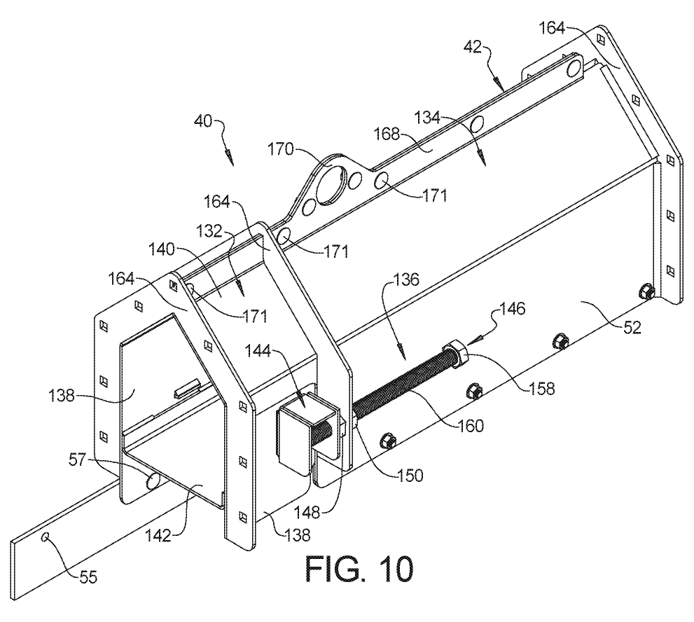

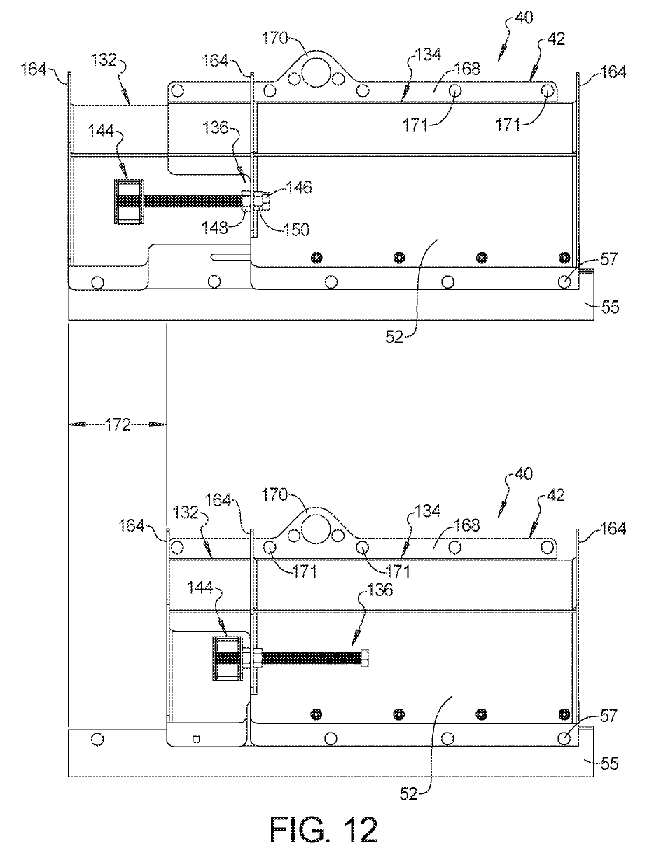

FIGS. 8, 9, and 13 through 16 and the top portion of FIG. 12 show the adjustable length section 40 in its fully extended state. FIG. 10 and the bottom portion of FIG. 12 show the adjustable length section 40 in its fully collapsed state. FIG. 12 illustrates a distance 172 by which the length of the adjustable length section 40 is changed when the adjustable length section 40 is switched between its fully extended state and fully collapsed state. The distance 172 may be greater than or equal to 12 inches (30.5 centimeters). For example, the length of the paddle sweep assembly 12 may be increased within a range from 0 inches to 12 inches relative to its fully collapsed state.

The shank 160 of the bolt 146 extends through a hole in the other flange 164 of the second frame segment 134 (i.e., the flange 164 of the second frame segment 134 that is not attached to the flange 164 of an adjacent frame segment using the fasteners 166). The shank 160 of the bolt 146 also extends through the hole 162 in the one side wall 152 of the bracket 144, and the end of the shank 160 opposite of the head 158 abuts the other side wall 152 of the bracket 144. The first and second nuts 148 and 150 are threaded onto the shank 160 of the bolt 146 and positioned on opposite sides of the other flange 164 of the second frame segment 134. When tightened against the other flange 164 of the second frame segment 134, the first and second nuts 148 and 150 collectively act as a jam nut that locks the bolt 146 in place.

To adjust the length of the paddle sweep assembly 12 (i.e., to adjust the distance 172), one of the first and second nuts 148 and 150 is loosened so that the bolt 146 can be rotated. The other one of the first and second nuts 148 and 150 can be fixed (e.g., welded) to the other flange 164 of the second frame segment 134. Thus, when the one nut 148 or 150 is loosened, the bolt 146 can be rotated clockwise to increase the distance 172, and the bolt 146 can be rotated counterclockwise to decrease the distance 172. The end of the shank 160 opposite of the head 158 remains abutted against the other side wall 152 of the bracket 144 while the distance 172 is adjusted. Once the distance 172 is adjusted as desired, the loosened nut 148 or 150 is tightened to lock the bolt 146 in place again.

In addition, to adjust the length of the paddle sweep assembly 12, a link is added to or subtracted from the first chain 44 to increase or decrease the length of the loop formed by the first chain 44. For example, to increase the length of the loop formed by the first chain 44, a link is added to the first chain 44 before rotating the bolt 146 clockwise to increase the distance 172. Conversely, to decrease the length of the loop formed by the first chain 44, a link is subtracted from the first chain 44 after rotating the bolt 146 counterclockwise to decrease the distance 172.

Furthermore, the paddle subassembly requires some sort of adjustment in order to maintain tension in the first chain 44. For example, the first shaft 70 in the head section 36 and/or the second shaft 90 in the tail section 38 may be made adjustable in the radially inward and outward directions 22 and 34. Making the first shaft 70 and/or the second shaft 90 adjustable in this way requires additional parts and increases cost and complexity. In addition, making the first shaft 70 and/or the second shaft 90 adjustable in this way is unnecessary because the adjustment mechanisms 36 can also be used to maintain tension in the first chain 44. Thus, the first shaft 70 and the second shaft 90 are fixed in the radially inward and outward directions 22 and 34, and the amount by which the first and second frame segments 132 and 134 overlap is adjusted to adjust the tension in the first chain 44.

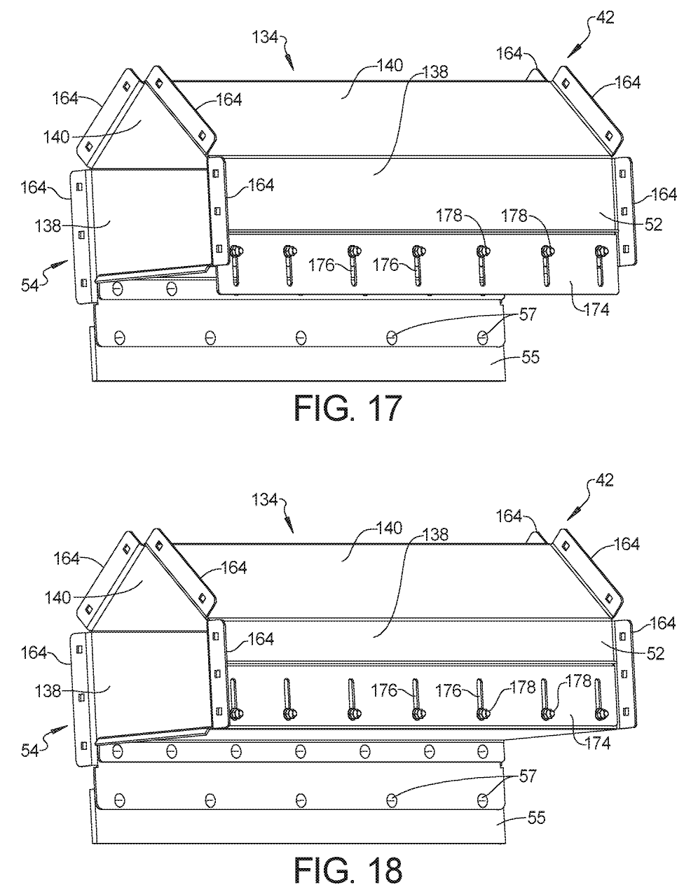

Referring now to FIGS. 17 and 18, an alternative embodiment of the second frame segment 134 is shown. In this alternative embodiment, the second frame segment 134 includes a flow restrictor plate 174 attached to the front side 52 of the frame 42. The flow restrictor plate 174 is vertically adjustable to increase or decrease the amount of grain that enters underneath the frame 42 and is pushed toward the center of the grain bin by the paddle sweep assembly 12 as it rotates around the grain bin. More specifically, the flow restrictor plate 174 is adjusted to an upward position as shown in FIG. 18 to allow more grain to enter underneath the frame 42, and the flow restrictor plate 174 is adjusted to a downward position as shown in FIG. 17 to allow less grain to enter underneath the frame 42. The ability to adjust the amount of grain that is pushed toward the center of the grain bin may be helpful when the capacity of the paddle sweep assembly 12 exceeds the capacity of the conveyor auger assembly 14 or vice versa. Thus, the flow restrictor plate 174 may provide a lower cost alternative to including a variable frequency drive for the motor 32 to decrease the speed of the paddle sweep assembly 12 so that its capacity does not exceed the capacity of the conveyor auger assembly 14.

The flow restrictor plate 174 defines a plurality of vertical slots 176. The flow restrictor plate 174 attached to the front side 52 of the frame 42 using fasteners 178 (e.g., nuts and bolts) that extend through the vertical slots 176 in the flow restrictor plate 174 and through corresponding holes in one of the side walls 138 of the frame 42. To adjust the height of the flow restrictor plate 174, the fasteners 178 are loosened, the flow restrictor plate 174 is moved up or down, and the fasteners 178 are retightened.

In this alternative embodiment, the second frame segment 134 does not include the flange 168 that projects from the upper edges of the top walls 140, or the fasteners 171 that extend through the flange 168 to join the front and back sides 52 and 54 of the frame 42 to one another. Rather, the front and back sides 52 and 54 of the frame 42 are integrally formed as one piece. In addition, each flange 164 does not extend around the entire perimeter of one of the openings in the second frame segment 134. Rather, each flange 164 extends along only one side of the perimeter of one of the openings in the second frame segment 134 (e.g., one of the side walls 138 or one of the top walls 140). Although FIGS. 17 and 18 only show the second frame segment 134, it should be understood that other segments of the frame 42 (e.g., the first frame segment 132) may include the flow restrictor plate 174 and/or may be made with their the front and back sides 52 and 54 integrally formed as one piece.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

When an element or layer is referred to as being "on," “engaged to,” "connected to," or "coupled to" another element or layer, it may be directly on, engaged, connected or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

As used herein, the term "and/or" includes any and all combinations of one or more of the associated listed items. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A paddle sweep assembly for a grain bin, the paddle sweep assembly comprising:
a frame;
a chain extending in a loop within the frame and coupled to the frame in a way that allows the chain to rotate through the loop; and
a plurality of paddles connected to the chain, wherein the length of the paddle sweep assembly is adjustable.

2. The paddle sweep assembly of claim 1 wherein the frame includes a first frame segment, a second frame segment, and at least one adjustment mechanism that connects the first second frame segments together and is manipulatable to increase or decrease an amount by which the first and second frame segments overlap, and thereby increase or decrease the length of the frame.

3. The paddle sweep assembly of claim 2 wherein one end of the loop formed by the chain is coupled to the frame on one side of the at least one adjustment mechanism along the length of the frame, and the other end of the loop formed by the chain is coupled to the frame on the other side of the at least one adjustment mechanism along the length of the frame.

4. The paddle sweep assembly of claim 2 wherein the chain includes a number of links, and the number of the links included in the chain is adjustable to adjust the length of the loop formed by the chain.

5. The paddle sweep assembly of claim 2 wherein the first frame segment is slidable within the second frame segment in a telescoping manner.

6. The paddle sweep assembly of claim 2 wherein the at least one adjustment mechanism includes a first adjustment mechanism attached to a front side of the frame and a second adjustment mechanism attached to a back side of the frame.

7. The paddle sweep assembly of claim 2 wherein the at least one adjustment mechanism includes a bracket, a bolt, and a pair of nuts, the bracket is attached to one of the first and second frame segments, the bolt extends through a flange on the other one of the first and second frame segments and abuts the bracket, and the nuts are threaded onto the bolt on opposite sides of the flange to lock the bolt in place.

8. The paddle sweep assembly of claim 7 wherein the bracket includes a pair of side walls and the bolt extends through a hole in one of the side walls and abuts the other one of the side walls.

9. The paddle sweep assembly of claim 7 wherein the flange projects from the perimeter of the other one of the first and second frame segments and extends along at least one side thereof.

10. The paddle sweep assembly of claim 7 wherein loosening one of the nuts enables the bolt to be rotated, and rotating the bolt adjusts the amount by which the first and second frame segments overlap.

11. The paddle sweep assembly of claim 2 wherein each of the first and second frame segments includes at least one top wall, a bottom wall, and a pair of side walls opposite of one another and joining the top and bottom walls together.

12. The paddle sweep assembly of claim 11 further comprising a flow restrictor plate attached to one the side walls of at least one of the first and second frame segments on a front side thereof, wherein the flow restrictor plate is vertically adjustable.

13. A grain bin emptying assembly comprising:
the paddle sweep assembly of claim 1 further including a drive gear coupled to the frame and a driven gear coupled to the frame, wherein the chain extends in the loop around the drive gear and the driven gear; and
a motor coupled to the drive gear, wherein the motor is operable to rotate the drive gear and thereby rotate the chain through the loop.

14. The grain bin emptying assembly of claim 13 further comprising a pivot mechanism coupling the drive gear to the motor and a drive wheel supporting the frame, wherein the drive wheel is coupled to the driven gear such that rotating the chain rotates the frame about the pivot mechanism.

15. The paddle sweep assembly of claim 1 wherein the length of the frame is adjustable by a distance that is greater than or equal to 30.5 centimeters.

16. A grain bin emptying assembly comprising:
a pivot mechanism configured to be located at or near a center of a grain bin; and
a paddle sweep assembly operable to rotate around the grain bin about the pivot mechanism, the paddle sweep assembly including a frame attached to the pivot mechanism, a chain extending in a loop within the frame and coupled to the frame in a way that allows the chain to rotate through the loop, and a plurality of paddles connected to the chain and configured to push grain toward the center of the grain bin, wherein the length of the paddle sweep assembly is adjustable.

17. The grain bin emptying assembly of claim 16
wherein the paddle sweep assembly includes a drive gear coupled to the frame and a driven gear coupled to the frame, the chain extending in the loop around the drive gear and the driven gear, the grain bin emptying assembly further comprising a motor coupled to the drive gear, wherein the motor is operable to rotate the drive gear and thereby rotate the chain through the loop.

18. The grain bin emptying assembly of claim 16
wherein the frame includes a first frame segment, a second frame segment, and an adjustment mechanism, the first frame segment being slidable within the second frame segment in a telescoping manner, the adjustment mechanism connecting the first second frame segments together and being manipulatable to increase or decrease an amount by which the first and second frame segments overlap, and thereby increase or decrease the length of the frame.

19. The grain bin emptying assembly of claim 18
wherein one end of the loop formed by the chain is coupled to the frame on one side of the adjustment mechanism along the length of the frame, and the other end of the loop formed by the chain is coupled to the frame on the other side of the adjustment mechanism along the length of the frame.

20. The grain bin emptying assembly of claim 18
wherein the adjustment mechanism includes a bracket, a bolt, and a nut, the bracket is attached to one of the first and second frame segments, the bolt extends through a flange on the other one of the first and second frame segments and abuts the bracket, the nut is threaded onto the bolt and fixed to the flange, and rotating the bolt adjusts a distance between the bracket and the flange.
